(19) United States
(12) Patent Application Publication
(10) Pub. No.: US 2002/0055881 A1
(43) Pub. Date: May 9, 2002

(54) Local electronic commerce system using terminal and method thereof

(76) Inventor: Dong Joon Han, Cupertino, CA (US)

Correspondence Address: BAKER & MCKENZIE, 805 THIRD AVENUE, NEW YORK, NY, 10022, US

(21) Appl. No.: 09/865,020

(22) Filed: May 24, 2001

(30) Foreign Application Priority Data
Nov. 9, 2000 (KR) 2000-66438

(51) Int. Cl. G06F 17/60

(52) U.S. Cl. 705/26

(57) ABSTRACT

Disclosed is a local electronic commerce system and a method thereof to establish transactions between consumers and distributors by using dedicated terminals. The local electronic commerce system according to the invention includes a local electronic commerce server and dedicated terminals equipped by distributors and consumers. A consumer accesses the server by using the consumer's terminal to inquire and order specific commodities as well as to settle payment of fees of the ordered commodities and to receive a transaction receipt from the server. The server orders the commodities to the distributors' terminal and settles payment of the fees of the order commodities. The consumer ultimately exchanges the transaction receipt with the commodities. The invention enables ordinary consumers who are not familiar with the internet or computers to conduct electronic commerce with ease and convenience. The invention also prevents leakage of personal credit information of the consumers by completely separating consumers from distributors by the server.

### BACKGROUND OF THE INVENTION

1. Field of the Invention

The present invention relates to a local electronic commerce system using dedicated terminals and a method thereof to realize effective electronic commerce between consumers and distributors in a particular local area by using dedicated terminals.

2. Description of the Related Art

Ordinary types of electronic commerce are B2C (between business corporations and consumers), B2B (between business corporations), and B2G (between business corporations and government bodies). In case of the ordinary B2C, consumers get access to internet shopping mall sites to register memberships, search and order necessary goods, and settle payment. However, this process can be burdensome the consumers who are not familiar with the internet or computers. Further, consumers are vulnerable to leakage of their personal credit information disclosed in the course of ordering the goods.

Meanwhile, when purchasing goods of more than one item from an internet-based shopping mall, e.g., when purchasing a book from an internet bookstore and to purchase a TV, a consumer needs to access a bookstore site first, input personal information to register his/her membership, order a book, and then access another site selling electronic goods, input personal information, and order electronic goods. Thus, the consumers bear inconveniences of getting access to different shopping malls to register themselves as members whenever they purchase different kinds of goods.

Also, under the conventional electronic commerce, the consumers need to search numerous sites for purchasing various types of goods, such as home appliances, food stuff, books, etc. Moreover, it is not easy for consumers to compare prices of each shopping mall for the same item.

In addition, it is difficult for consumers who have ordered a commodity from a conventional internet shopping mall to check whether or not the order has been duly received.

The more serious problems in the electronic commerce are attributable to distributors. It is a reality that so-called “logistics costs” greatly affect the profits of the electronic commerce dealers. Consumers generally desire transaction safety and savings of purchasing costs in addition to the convenience of electronic commerce. Because of the logistics costs, i.e., of the delivery costs, however, it is difficult for distributors to lower the prices of goods so as to be discriminated from existing distribution off line retailers. The reason lies in the characteristics of internet or on-line commerce that is unpredictable as to what kinds of commodities the consumers would purchase from which area. Therefore, the logistic warehouses cannot be utilized as a base of logistics, and in reality, the increased logistics costs result in less profits for electronic commerce conducted in a wide area.

### SUMMARY OF THE INVENTION

It is, therefore, an object of the present invention to provide a local electronic commerce system, in which consumers can conveniently conduct electronic commerce within a local area by using an dedicated terminal, and a method thereof.

It is another object of the present invention to provide a local electronic commerce system, which can securely protect personal credit information on consumers by completely separating distributors from the consumers.

It is still another object of the present invention to provide a method for drastically reducing logistics costs and delivery costs of the commodities.

To achieve the above objects, there is provided a method of local electronic commerce using a transaction server for an electronic commerce between distributors and consumers having dedicated terminals, respectively, in accordance with information on a predetermined local area inputted by the consumer, the server being provided with a database for storing data of commodities of the distributors available in the predetermined local area, the method comprising the steps of: the consumer's terminal accessing the server; the server receiving from the consumer's terminal information on the local area to which the commodities are to be delivered; the server transmitting to the consumer's terminal the commodity data of the distributors corresponding to the local area information using the database; the server receiving an order for the commodities from the consumer's terminal; and the server transmitting the order for the commodities to the distributor's terminal.

The method performed by the server may further comprise the step of receiving from the consumer's terminal an identity of the consumer. The step of receiving the identity of the consumer is performed by receiving by on-line from the consumer's terminal a purchase card of the consumer inputted to the consumer's terminal.

The step of receiving the information on the local area is performed by receiving the information on the local area from at least one of the purchase card of the consumer and the consumer's terminal pre-storing the information on the local area. The method performed by the server may further comprise the step of transmitting a transaction receipt to the consumer's terminal.

Also, there is provided a consumer's terminal for a local electronic commerce system, comprising: a display section; an ID card input section; means for inputting information on an area where commodities are available; means for inputting an order for the commodities; and an on-line linking section for accessing the system by on-line. The meaning of the commodities' available area in this invention is an area where delivery or shopping of the commodities is very comfortable, easy or can be done in relatively short time due to short distance. The area may be classified and preset in the transaction server of this invention by algorithm made on above schemes. If the consumer inputs information on commodities' available area, it may be an area to which the consumer desires the ordered commodities to be delivered or it may be an area where the consumer wants to shop. Then, the information on commodities of the distributors who were classified and designated as the “local” distributors of the area according to said algorithm will be transmitted to the consumer's terminal. The algorithm can be made on the basis of geographic distance or specific transaction zone. That is, the information on the local area may be on a city, a district, a town or a village under the administrative division of areas, or on a certain residential area such as a particular apartment.

The step of receiving information on the local area may be performed in the manner of receiving the information on the local area from any one or more of the consumer's purchase card and a consumer's terminal, in which the information on the local area is pre-set, or in the manner of directly inputting a designated area code or a name.

The means for inputting orders of commodities in the consumer's terminal includes at least one selected from a group comprising touch screen means, bar code input means, character input means, and mouse input means. Employing the bar code input means is advantageous for easily ordering a commodity by scanning a bar code portion of a package or a container of the commodity used previously without inputting a name or a code of the commodity. A keyboard may not be necessary in that case.

The consumer's terminal further comprising a printing section for outputting at least one selected from a group comprising transaction certificates, discount coupons, reservation tickets, lottery tickets, medical prescriptions, and certificates issued by government bodies.

The on-line linking section of the consumer's terminal includes means for wirelessly accessing on-line. It means that it may be a form of mobile type device. Also, it may be combined with a typical PDA, cellular phone, etc. In this case, the PDA, cellular phone, etc. will have the characteristics of the consumer's terminal of this invention in addition to its typical functions. A standardized technology such as an ordinary blue tooth method or an IMT-2000 can be used for the wireless on-line technology.

There is also provided a consumer's terminal for a local electronic commerce system including an ID card input section, means for inputting an order for commodities, and means for inputting information on an area where commodities are available; wherein the terminal is linked to at least one of a computer system and a bi-directional television system.

There is also provided a distributor's terminal for a local electronic commerce system, comprising: a display section; an ID card input section; means for inputting data of commodities available within a specified area; and an on-line linking section for accessing the system on-line. The data of commodities available within specific areas are input with specific area code or name, which is classified on the basic algorithm that the distributor can deliver in relatively short time within that area or the customer may purchase the commodities easily in that area. The area code or area name may be stored in the distributor's terminal and automatically transmitted whenever the distributor inputs or updates its data of commodities.

There is also provided a local electronic commerce system having a local electronic commerce server for performing transactions between local distributors and consumers that include the steps of: the distributor and the consumer accessing the server using dedicated terminals, respectively; the server recognizing an identity of the consumer accessing the server; the server receiving information on the local area where commodities are available; the server transmitting information on the commodities available within the area to the consumer's terminal; the server receiving settlement of a payment for ordered commodities if an order for the commodities is transmitted from the consumer; transmitting a transaction receipt to the consumer's terminal according to the payment; and the server settling payment for the commodities after transmission of the order for the commodities to the distributor's terminal.

In the local electronic commerce system as described above, the consumer may output the transaction receipt transmitted from the server so as to be exchanged with the commodities. If the consumer settles the payment for the purchased commodity before or after the above steps, a type of transaction combining on-line with off-line can be performed in the manner that the transaction server transmits evidence of transaction, i.e., a receipt, to the consumer's terminal so that the consumer can output the same to exchange with the commodity.

The step of receiving an identity of the consumer by the transaction server in this invention may be performed by receiving an identity of the consumer on-line after the consumer's purchase card is inputted to the consumer's terminal so that the information on the consumer's purchase card can be compared with the information on the consumer pre-stored in the consumer's terminal, and when the compared information is matched with each other. As a preceding step, it may be possible to pre-store information distinguishing consumers in the consumer's terminal, input the consumer's purchase card to the consumer's terminal, and compare the card information with the stored information so as to start transactions only when the compared information is matched with each other. Thus, transactions start only when a particular card is inserted to a particular terminal, and a transaction safety is guaranteed even if either the consumer's card or the consumer's terminal is lost. Here, the consumer's information compared to check matching with the card information is not necessarily the information on the consumer's personal information but may be any kind of information that can distinguish the consumer, including a password or an ID of the consumer.

Also, the display section of the consumer's terminal of this invention may display a category of the commodity currently selected by the consumer together with all of the broader categories of commodities.

The step of transmitting the commodities data of the distributor in this invention may be performed by transmitting the commodities data including the predicted information on the to-be-purchased commodities. Also, it may be performed by transmitting chronological information on the history of purchased commodities.

The consumer's terminal may take the form of a peripheral device of the existing systems such as a computer system or a bi-directional TV system linked on-line. In that case, the systems may be used as communication stations or displaying devices, and conducting transactions may be implemented by inputting an ID card into the consumer's terminal. Then, the consumer's terminal may only be ordering devices without any expensive modules such as communication modules, displaying modules or printing modules.

The distributors' terminal may have a similar structure to the consumers' terminal. To be specific, the distributor's terminal may include a display section, an ID card input section, data input means, and an on-line linking section for automatic on-line accessing. The distributor's terminal has a function of approving transactions or delivery of commodities upon input of an ID card by a sales clerk or a manager. The distributor's terminal may have additional finctions of administering the stocks in the shop, keeping transaction specifications transmitted from the consumers' terminal, and collecting statistics of the same as well as of outputting the transaction-related evidentiary materials by using the output section.

The present invention serves to drastically reduce logistics costs by linking local shops to the consumers in the corresponding local area in a kind of community manner so that the delivery or shopping of the commodities can be limited to the local area.

The present invention further enables ordinary consumers who are not familiar with accessing internet and using computers to conveniently and easily conduct electronic commerce by means of an dedicated terminal. The present invention also serves to fully protect personal credit information on consumers by completely separating the distributors from the consumers.

### BRIEF DESCRIPTION OF THE DRAWINGS

The above and other objects, features and advantages of the present invention will become more apparent from the following detailed description when taken in conjunction with the accompanying drawings, in which:

FIG. 1 is a front view of a consumer's terminal used in a local electronic commerce system according to the present invention;

FIG. 2 is a block diagram illustrating the local electronic commerce system according to the present invention; and

FIG. 3 is a flow chart illustrating an operation of the system according to the present invention.

### DETAILED DESCRIPTION OF THE PREFERRED EMBODIMENTS

Preferred embodiments according to the present invention will now be described herein below with reference to the accompanying drawings.

The local electronic commerce system according to the present invention comprises a distributor, a consumer, and a local electronic commerce server enabling electronic commerce between the distributor and the consumer. The distributor uses a distributor's terminal, while the consumer uses a consumer's terminal to conduct electronic commerce by accessing the local electronic commerce server.

The “local” area here may be an existing administrative concept but is preferably a unit area, in which economic activities can be conducted in short time. The local area may range from satellite cities such as Ilsan or Bundang at the maximum to an apartment ward at the minimum. The distributor's shopping mall located near to or in such a particular local area is referred to as a local shopping mall. But even if the local electronic commerce system network is established in each local area, use of the other local electronic commerce systems through the network is available if necessary.

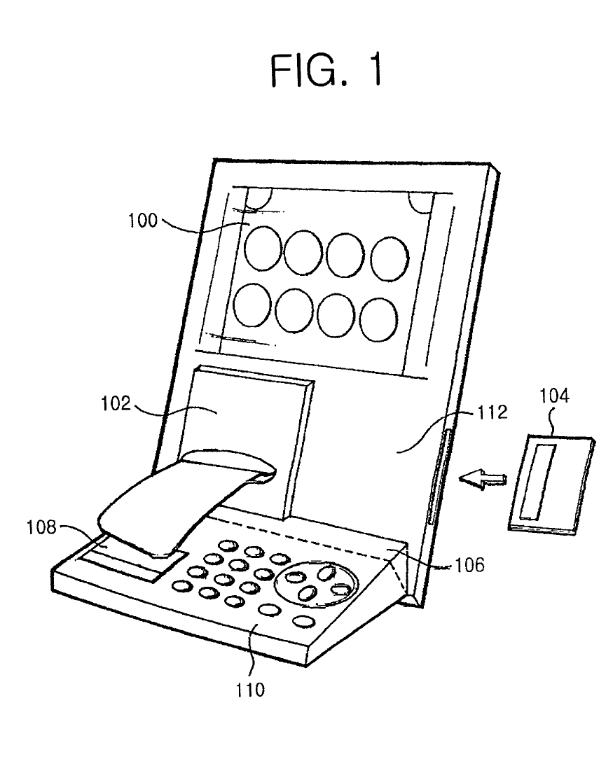

FIG. 1 is a front view of a consumer's terminal used in a local electronic commerce system according to the present invention. The structure and functions of a dedicated terminal, and particularly a consumer's terminal used in the system according to an embodiment of the present invention will now be described with reference to FIG. 1. The embodiments described herein below are merely to facilitate understanding of the present invention and are not intended to limit the scope of the claims of the present invention.

The dedicated terminals are classified into two: consumer's terminals and distributor's terminals. One embodiment of the consumer's terminal may comprise a display section 100 having a touch screen function, an on-line linking section (not shown in the drawing) for communication, especially in internet or intranet, and a printing section 102 having a unauthorized-printing protection function. In addition, the consumer's terminal may further comprise numeric keys 110, direction keys, a bar code reader 108, an ID card (e.g., a smart card) 104, and an ID card reader 106. The consumer's terminal may further comprise a speaker, and a microphone 112 as input devices.

A distributor's terminal used by distributors also comprises, as in case of the consumer's terminal, a display section having a touch screen function, an on-line linking section for automatically accessing on-line, especially internet, simultaneously with operation of the terminal, and a printing section. Preferably, the distributor's terminal may further comprise basic input and output sections including an ID card reader.

The terminals per se may be constructed to implement transactions according to the present invention though an access to an on-line network including the internet. Otherwise, the terminals may take the form of a peripheral device including an ID card reader and a transaction receipt output unit by being connected to a computer system or a bidirectional TV system linked on-line. In this case, the computer system or the bidirectional TV system may be used as a transmission means or display means which connects the terminal to the network.

The terminals may take the form of mobile apparatus similar to a cellular phone, a PDA, and an ID card reader, etc. If the terminals are mobile forms, more convenient transactions can be conducted while moving. In this case, the terminal will have additionally a wireless transmission means and adequate protocols such as WAP (wireless application protocol), etc., which interfaces the mobile terminal and the web server used as the local electronic commerce server.

When an ID card reader is to be included, the distributor's terminal may be constructed to allow different inputs through a single terminal in accordance with the card- work level degrees. For instance, a sale clerk using the distributor's terminal by inserting his/her own ID card thereto, establishment of a transaction and delivery of an ordered commodity can be inputted. On the other hand, a manger can secure stable transactions and an effective management by setting the stocks and revision of the ordered contents by inserting manager's card in advance for discriminated work performance.

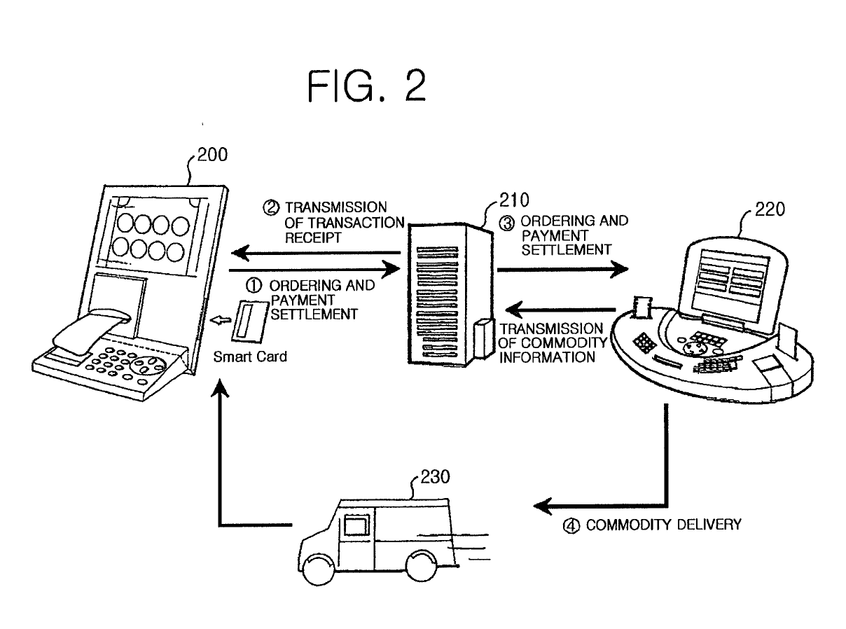

The construction and operation of the system according to the present invention will now be described based on the aforementioned dedicated terminals with reference to FIG. 2.

FIG. 2 is a block diagram illustrating the local electronic commerce system according to the present invention. Referring to FIG. 2, The local electronic commerce system according to the present invention comprises a local electronic commerce server 210 for providing electronic commerce services in a particular local area, a distributor's terminal, and a consumer's terminal for communicating with the server 210. In case of dedicated terminals, consumer's terminals are installed in each household, while the distributor's terminals are installed in each shop. The construction and function of the dedicated terminals are as described above. The server 210 provides diverse services for distributors and consumers by establishing a database of a variety of commodities available by the shops within the local area. Although the server 210 is called as a “local server”, it may not need to be located within specific areas. The means of the “local server” in this invention is that the server can manage the transaction of this invention.

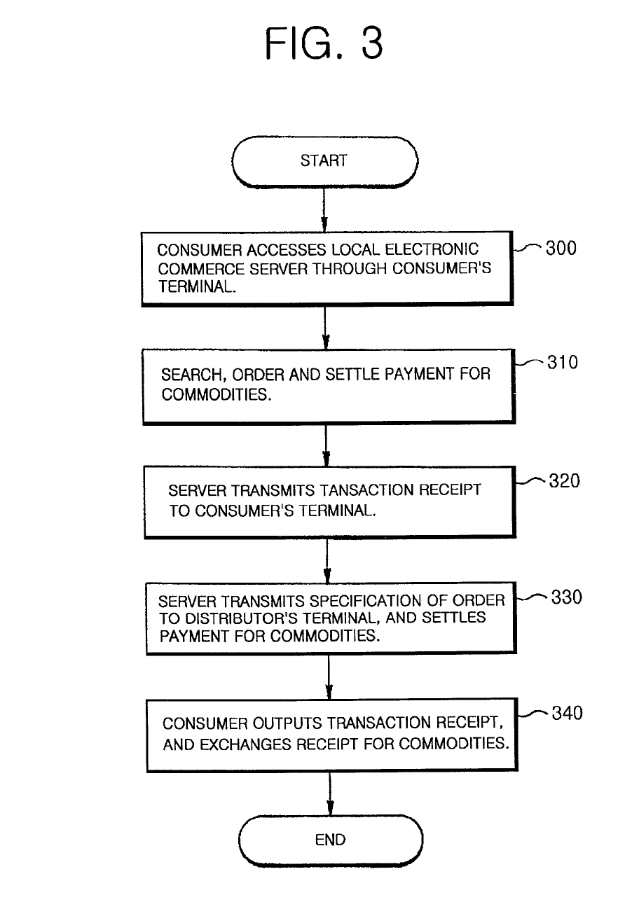

An operation of the system according to the present invention will now be described with reference to FIG. 3.

FIG. 3 is a flow chart illustrating an operation of the system according to the present invention. Referring to FIG. 3, a consumer who desires to purchase a commodity from a shop within a particular local area accesses the local electronic commerce server 210 by means of the consumer's terminal in step 300. Immediately after the access, the consumer may proceed with step 310 to search commodities, or may additionally undergo step 350 to seek an authentication from the server 210 by transmitting the data established in a transaction ID card such as a smart card to the server 210, or to confirm his/her identity from the server 210 by inputting his/her own ID or password. Another method of identifying the consumer may be taken by determining whether or not the consumer's terminal is matched with the consumer's ID. For instance, if a particular consumer's terminal is constructed to be matched with a particular ID card, the matching is checked for transaction. This is a device for transaction safety to prevent loss of an ID card or an unfair transaction because no transaction is established when either the ID card or the terminal is lost.

The server undergoes step 350 to identify the consumer based on the input from the consumer's terminal, and transmits information on the commodities. Otherwise, the server directly transmits information on the commodities of each shop immediately after accessing on-line without undergoing the step 350. In that case, step 360 needs to be undergone for identification of the consumer when ordering commodities. The information on commodities to be transmitted may include the predicted information on the to-be-purchased commodities generated based on the information on the commodities pre-stored in the database of the transaction server as having been reserved to be purchased at regular intervals or the chronological information on the consumer's purchase history. For instance, the information on powdered milk or diapers reserved for purchase once every week or on a particular kind of noodle favored by the consumer. Those reversed commodities may be displayed on a most distinctive part of the screen that can draw the consumer's attention for purchase. In addition to the information on the commodities, classified information on frequently purchased commodities may also be transmitted.

In step 310, the consumer searches information on the commodities provided by the server to select desired items. The information on the commodities may include information on the distributors, commodities as well as the prices when transmitted. If necessary, the information may include voice data or olfactory data. The consumers may easily select desired items by means of a touch screen, a mouse (not shown in the drawing), a keyboard or by inputting the barcode of the commodity. Input of voice through a voice recognition technology is also available.

The manner of displaying commodities to the consumer may be any one of the display methods used in the ordinary electronic commerce. In particular, when displaying commodities in a classified manner, the consumer should be able to approach information on the commodities by searching from the broadest category to the individual ones. In that case, it is common to allow searching of the commodities by uploading separate screens for each category. However, the consumer who desires to purchase commodities of different categories generally should surf numerous separate screens by using a forward button or a backward button provided on a browser, etc. This poses inconveniences on the consumer in browsing the commodities due to displays with slow speed. Also, the consumer might lose his/her desire to purchase the commodities if lost in the course of surfing the paths.

To prevent this risk, the present invention employs a method of simultaneously displaying screens with different-sized frames from the periphery of the screen. Commodities of the broadest category appear on the most outer periphery of the screen, and more specified commodities appear on the inner part of the screen. To be specific, if the consumer selects any one of the commodities of the broadest category, the commodities of the second broadest category which belong to the broadest category appear on the screen with a smaller frame. The second frame screen is displayed to overlap only a part of the first frame screen. Therefore, the non-overlapped part of the first frame screen still displays the commodities of the broadest category on a reduced scale. If the consumer selects any one of the commodities of the second category, a third frame screen appears to display commodities of the third category in the manner of overlapping a part of the second frame screen. The non-overlapped part of the second frame screen still displays the commodities of the second broadest category on a reduced scale. If displayed in this manner of reducing the frames, categorized lists of commodities are displayed on parts of the screen, while specific information on a particular commodity desired by the consumer also appears on the screen. Therefore, much more options are available for the consumer in comparison with the conventional method. Here, the reduced lists of commodities may take a format of a hypertext such as an HTML so that the consumer can jump to another category whenever he or she selects the pertinent one.

The characteristic feature of the present invention lies in that all of the categories selected by the consumer continuously appear on the screen. Other displaying methods may be variable within the technical concept of the present invention by those skilled in the art.

Upon selection of the desired items, the consumer transmits an order to the server. If no identifying process has been taken in an initial access, the consumer transmits information for settlement by means of an ID card reader mounted on the consumer's terminal (step 360). This identification is the one confirming the consumer before the transactions are substantially established as in case of settling the payment by using a credit card. The identification at this stage is performed in the same or similar manner to the one performed in step 350. Although the embodiment of the present invention describes undergoing either step 350 or step 360 only, both of these steps may be undergone if necessary.

Smart cards are an example of the ID card. In addition, however, any kinds of cards designating an individual or a legal person, including credit cards or electronic ID cards, are available, as long as a reader is properly provided. The ID card contains information on the local area related to the consumer. Therefore, it is possible to initially provide information on commodities of the distributors existing in the corresponding local area when linking the server. Then, the distributors in a particular local area will respond to the orders from the pre-set local area only. Because the area subject to delivery of the commodities is limited, the logistics costs may be drastically reduced in comparison with the ordinary electronic commerce which has no area limitation.

The information on a local area may be inputted to the consumer's ID card. To the contrary, however, the information on a local area may be stored in the consumer's terminal in advance. In that case, the consumer can order commodities by means of any dedicated terminals with his/her own ID card. Since the information on the local area where the dedicated terminal exists is transmitted to the transaction server, transactions are established with the distributors in the corresponding local area.

According to a third embodiment of the present invention, if the consumer inputs a local area where the commodities are to be delivered, the distributors subscribed to the transaction server within the local area only can be designated for transactions. In that case, the consumer directly inputs the information on the local area. As a consequence, the information on the distributors selected in advance from those in the corresponding local area is transmitted initially so that the consumer can purchase commodities from those distributors. This is another way of saving the time and costs taken for delivering the commodities as well as of widening the scope of purchasing option of the consumer.

If on-line and off-line shops equipped with distributor's terminals in each local area are established as a database in advance, and if the database is linked to the transaction server, it is possible to transmit data of each local area during transactions. In other words, the server has a database setting the distributors corresponding to the information on the pertinent local area. If the information on the local is inputted before or after input of an ID, the information on the distributors in the local area only is initially transmitted so that the consumer can select commodities based on the transmitted information. The information on commodities in other areas that are also transmittable is discriminated from the information on commodities in the local area so as to induce transactions within a particular local area. The available methods for discrimination are to discriminate delivery costs or to limit access.

The server settles payment for the commodities based on the information on the ID transmitted from the consumer. Thereafter, in step 320, the server transmits a transaction receipt for the settled commodities to the consumer's terminal. Around that stage, the order of the commodities is transmitted to the distributor's terminal 220 so that the distributor can prepare the ordered commodities.

In step 330, the distributor's terminal issues a specification of the order of commodities so that the distributor can prepare commodities in accordance with the specification of the order thereof.

In step 340, the consumer outputs the receipt transmitted by the server by means of the printing section, e.g., a printer, mounted on the consumer's terminal so as to be exchanged with the commodities. It may be constructed to output the receipt immediately after completion of the transaction so as to eliminate the consumer's inconvenience with respect to completion of the transaction. At that stage, the consumer may directly exchange the receipt with the order commodities through visitation to the distributor's shop. Otherwise, the delivery system operated by the distributor may deliver the commodities to the consumer's house and the consumer may exchange the receipt and the commodities at his or her house.

Meanwhile, the distributor can input and transmit information on the commodities or discount coupons by means of the distributor's terminal. This process can be performed in real time when the consumer purchases commodities. Statistic materials including the stocks and specifications of orders can be checked by interlocking a POS system within the like and the local electronic commerce server.

Distributors may provide a variety of additional services for the consumer via the server. For example, distributors (and the server) can provide services such as outputting diverse reservation tickets including cinemas, sports, performances as well as lottery tickets and various certificates issued by the government bodies through the consumer's terminal. The server can also output discount commodity coupons issued by each shop as well as medical prescriptions. Furthermore, the server can provide each consumer with management functions including the management of shopping lists of each consumer, shopping orders and shopping schedules through the consumer's terminal. The server can also provide each shop with management functions including the management of catalogs, coupon services and the like through the distributor's terminal.

The present invention realized advantages of an off-line commerce through on-line by activating the on-line transactions conducted in a particular local area. This means that the present invention serves to promote a more active electronic commerce through savings of delivery costs and building reliability among the transaction partners.

Further, the present invention enables ordinary consumers who are not familiar with the internet or computers to conduct transactions with convenience by means of dedicated terminal. By completely separating distributors from consumers with a local electronic server, the present invention also prevents the possibility of leaking personal credit information.

Furthermore, when purchasing more than one kind of commodity from internet shopping malls, a consumer need not access each shopping mall to register membership thereof. Instead, the consumer can purchase commodities from any shopping malls linked to the local electronic commerce server without repeated registration after registering himself/herself at the server as a member.

Moreover, if the consumer inputs a name of the desired commodity to the server, the server provides a list of available shops within the local area together with the comparative prices of the same commodity sold in each shop. Therefore, the consumer need not search internet shopping malls.

In addition, the consumer who is able to directly output transaction receipts upon completion of orders and settlement of the fees can confirm whether or not his/her own orders have been duly received. The consumer can also transact with reliability on the commodities sold by the familiar transaction partners within the particular local area.

From the distributor's point of view, the distributors can not only secure stability of transactions by using an dedicated terminal but also drastically save delivery costs by receiving local orders only. The distributors have an advantage of offsetting the limitation in securing the number of consumers by promoting the purchasing desires of the consumers with improvement of the service qualities in addition to saving the costs through the local electronic commerce according to the present invention. In particular, the distributors can resolve the most significant problems of securing reliability on their own commodities and high logistics costs.

What is claimed is:

1. A method of local electronic commerce using a transaction server for an electronic commerce between distributors and consumers having dedicated terminals, respectively, in accordance with information on a predetermined local area inputted by the consumer, the server being provided with a database for storing data of commodities of the distributors available in the predetermined local area, the method comprising the steps of:
(a) the consumer's terminal accessing the server;
(b) the server receiving from the consumer's terminal information on the local area to which the commodities are to be delivered;
(c) the server transmitting to the consumer's terminal the commodity data of the distributors corresponding to the local area information using the database;
(d) the server receiving an order for the commodities from the consumer's terminal; and
(e) the server transmitting the order for the commodities to the distributor's terminal.

2. The method according to claim 1, further comprising the step of the server receiving from the consumer's terminal an identity of the consumer.

3. The method according to claim 2, wherein the step of the server receiving the identity of the consumer is performed by receiving on-line from the consumer's terminal a purchase card of the consumer inputted to the consumer's terminal.

4. The method according to claim 1, wherein the step of receiving the information on the local area is performed by receiving the information on the local area from at least one of the purchase card of the consumer and the consumer's terminal pre-storing the information on the local area.

5. The method according to any one of claims 1 to 3, further comprising the step of transmitting a transaction receipt to the consumer's terminal after the step (d).

6. A consumer's terminal for a local electronic commerce system, comprising:
a display section;
an ID card input section;
means for inputting information on an area where commodities are available;
means for inputting an order for the commodities; and
an on-line linking section for accessing the system by on-line.

7. The consumer's terminal according to claim 6, wherein the means for inputting the order of commodities includes at least one among a touch screen, bar code input means, character input means, and mouse.

8. The consumer's terminal according to claim 6, further comprising a printing section for outputting at least one among transaction certificates, discount coupons, reservation tickets, lottery tickets, medical prescriptions, and certificates issued by government bodies.

9. The consumer's terminal according to any one of claims 6 to 8, wherein the on-line linking section includes means for wirelessly accessing the system.

10. A consumer's terminal for a local electronic commerce system including an ID card input section, means for inputting an order for commodities, and means for inputting information on an area where commodities are available;
wherein the terminal is linked on-line to at least one of a computer system and a bidirectional television system.

11. A distributor's terminal for a local electronic commerce system, comprising:
a display section;
an ID card input section;
means for inputting data of commodities available within a specified area; and
an on-line linking section for accessing the system by on-line.

12. A local electronic commerce system having a local electronic commerce server for performing transactions between local distributors and consumers that include the steps of:
the distributor and the consumer accessing the server using dedicated terminals, respectively;
the server recognizing an identity of the consumer accessing the server;
the server receiving information on local area where commodities are available;
the server transmitting information on the commodities available within the area to the consumer's terminal;
the server receiving settlement of a payment for ordered commodities if an order for the commodities is transmitted from the consumer;
transmitting a transaction receipt to the consumer's terminal according to the payment; and
the server settling payment for the commodities after transmission of the order for the commodities to the distributor's terminal.

13. The local electronic commerce system according to claim 12, wherein the consumer outputs the transaction receipt transmitted from the server so as to be exchanged with the commodities.

14. The method according to claim 2, wherein the step of receiving the identity of the consumer is performed by receiving the identity of the consumer on-line after the consumer's purchase card is inputted to the consumer's terminal so that the information on the consumer's purchase card can be compared with the information on the consumer pre-stored in the consumer's terminal, and when the compared information is matched with each other.

15. The consumer's terminal according to claim 6, wherein the display section of the consumer's terminal displays a category of the commodity currently selected by the consumer together with all of the broader categories of commodities.

16. The method according to any one of claims 1 to 3, wherein the step of transmitting the commodities data of the distributor is performed by transmitting the commodities data including the predicted information on the to-be-purchased commodities.

17. The method according to claims 1 to 3, wherein the step of transmitting the commodities data of the distributor is performed by transmitting chronological information on the history of purchased commodities.
